(19) United States
(12) Patent Application Publication
(10) Pub. No.: US 2022/0219587 A1
(43) Pub. Date: Jul. 14, 2022

(54) HEAD RESTRAINT

(71) Applicant: AUDI AG, Ingolstadt (DE)

(72) Inventors: Manuel WENZEL, Geisenfeld (DE); Haci Ramazan KELEPIR, Hilpoltstein (DE); Alexander KLUGE, Ingolstadt (DE)

(73) Assignee: AUDI AG, Ingolstadt (DE)

(21) Appl. No.: 17/604,127

(22) PCT Filed: Apr. 21, 2020
(86) PCT No.: PCT/EP2020/061035

§ 371 Date: Oct. 15, 2021

(30) Foreign Application Priority Data
May 9, 2019 (DE) 10 2019 206 715.8

(51) Int. Cl. B60N 2/879; H04R 1/02; H04R 1/28

(52) U.S. Cl. CPC B60N 2/879; H04R 2499/13; H04R 1/2803; H04R 1/025

(57) ABSTRACT

A head restraint for a vehicle seat for a vehicle for at least one person. The head restraint has a front side facing the person sitting on the vehicle seat and a rear side arranged opposite to the front of the head restraint. The head restraint has a head box and at least one foam body. The foam body is applied around at least part of the head box and covers at least a part of the head box arranged in the direction of the front side of the head restraint and also covers at least part of the part of the head box arranged in the direction of the rear side of the head restraint. The foam body is designed such that the part of the foam body which covers the rear side of the head restraint can form a resonance volume.

The invention relates to a head restraint for a vehicle seat for a vehicle for at least one person, wherein the head restraint has a front side which faces in the direction of the person sitting on the vehicle seat and a rear side which is arranged opposite to the front side of the head restraint.

Head restraints in vehicle seats are known such that the head restraint can be integrated directly into a backrest of a vehicle seat, so that a component results, or alternatively the head restraint is movably connected to the backrest of a vehicle seat via a frame. It is known that a vehicle seat also has a seat surface, at least in addition to the backrest against which the back of a person can be leaned, wherein the backrest and the seat surface are displaceable relative to one another. Alternatively, the backrest and the seat are arranged rigidly in relation to one another.

Integrating a loudspeaker into the head restraint of a vehicle seat so that the person can listen to music by means of the head restraint, for example during the journey on the vehicle seat, is furthermore known. The rear of the head restraint has a cover, for example a cover made of plastic, in order to be able to form a resonance volume on the rear side of the loudspeaker. Foam in the direction of the outside of the head restraint is provided over such a cover.

A head restraint for a vehicle is known from each of U.S. Pat. No. 3,944,020 A, US 2015/0298372 A1, and EP 3 370 439 A1.

The disadvantage is that the construction of a head restraint with a loudspeaker or without a loudspeaker is complex, so that, depending on the design of the head restraint, different structural solutions are possible, in particular when a loudspeaker is arranged in a head restraint.

The object of the invention is to create a possibility which enables a simple structural solution regardless of the design of the head restraint.

The object is achieved according to independent claim 1. Advantageous refinements of the invention result from the dependent claims.

To achieve the object, the head restraint has a head box and at least one foam body, wherein the foam body can be applied around at least part of the head box and at the same time covers at least a part of the part of the head box arranged in the direction of the front side of the head restraint and at the same time at least a part of the part of the head box arranged in the direction of the rear side of the head restraint and the foam body is designed such that the part of the foam body which covers the rear side of the head restraint, in particular the head box, can form a resonance volume.

It is thus advantageously possible that a simple structural solution in the form of a reduction of multiple components for the head box is enabled. A foam body can also be used independently of different variants of the head restraint, for example a head restraint with a loudspeaker or without a loudspeaker. In the variant with a loudspeaker, the foam body according to the invention is used as a resonance body on the rear side of the head restraint, which forms a resonance volume. This means that the foam body on the rear side dissipates sound waves from the loudspeaker by forming a resonance volume. The foam body thus acts as a resonance body.

According to the invention, it is thus possible to dispense with a further cover, which is intended to generate a resonance volume, between the loudspeaker and the rear side of the head restraint. Such a cover can be designed as a cover cap, for example. According to the invention, however, such a cover is not necessary. The foam body area in the direction of the rear side of the loudspeaker forms a resonance volume in that the open pores of the foam body accordingly absorb the sound waves that the loudspeaker emits from the rear side as a resonance body. The sound waves that are generated in the direction of the rear side by the loudspeaker thus diffuse into this foam body area on the rear side of the head restraint. There is a dissipation of sound waves in the foam body area on the rear side of the head restraint.

In a preferred variant of the head restraint, the head box is formed in one piece.

In a further preferred variant of the head restraint, the head restraint has at least one loudspeaker. For example, it is possible that the head restraint has two loudspeakers. The loudspeakers can be screwed to the head box by means of at least one screw.

In a further preferred variant of the head restraint, the loudspeaker is arranged between a rear side of the head box and an area of the foam body and a front side of the head box is covered only by the foam body. The loudspeaker itself is preferably oriented in the direction of the front side of the head restraint, so that the sound waves from the loudspeaker can be conducted in the direction of the person through the area of the foam body.

In the area of the foam body which forms the rear side of the head restraint, a dissipation of the back sound from a loudspeaker in the head restraint according to the invention thus takes place. No further cover is therefore necessary in order to generate such a dissipation effect. That is to say, the foam body carries out the dissipation according to the invention.

In a further advantageous embodiment, the foam body has at least one area that is perforated so that at least this perforated area of the foam body of the head restraint can be used for the transmission of at least one sound wave from the loudspeaker.

A perforation in the context of the invention is to be understood to mean that the foam body at this point has a different density than the foam body at another point of the foam body. Technically, this can be created in the foam by a special contour, for example at least one hole in the foam body. It is thus possible according to the invention that existing openings in the head box to conduct the sound from the loudspeaker in the head restraint fitting suitably through these openings are arranged overlapping or matching with the perforation in the foam body in front of these openings in the head box. Alternatively or additionally, further perforations can also be introduced into the foam body in order to emit the sound through the foam body. A perforation in the foam body according to the invention can thus be a hole, a special free form or, for example, a rhombus, a square, an ellipse, or the like. The respective perforation is preferably completely continuous through the foam body, that is to say, the sound can be conducted from the loudspeaker or head box through the perforation to the outside of the foam body.

In a further advantageous embodiment, the head restraint has a covering that covers the head box and the foam body, in particular the head box, the foam body, and the loudspeaker. Such a covering protects the head restraint from external influences and conceals the components of the head restraint.

It is possible that the covering consists of leather, cotton, and/or a polymer.

In a further advantageous embodiment, the covering is at least partially perforated, in particular is perforated in the area of the front side of the head restraint. As a result, a person can hear a tone, that is to say the sound wave, from the loudspeaker through the covering and the foam body particularly well.

In a further advantageous embodiment, the head box has at least one opening through which the sound wave from the loudspeaker can penetrate into the head restraint through the foam body, in particular the perforated area of the foam body. These sound waves are then preferably incident on the covering and subsequently on the person on the vehicle seat.

In a further advantageous embodiment, the foam body is formed in one piece.

In a further advantageous embodiment, the foam body is adapted to the contour of the head box, in particular having a cavity in the interior into which at least a part of the head box can be introduced, so that the head box is at least partially enveloped, in particular enveloping its front side and rear side. Parts of the two lateral areas and the upper area of the head box can also be enveloped by the envelope. The underside of the head box is preferably not enveloped. The underside lies opposite to the upper area of the head box and is arranged perpendicular thereto with respect to an imaginary axis between the front side and rear side or the two side areas, that is to say at a 90° angle.

A cavity can be understood in the sense of the invention in such a way that parts of the head restraint, such as the head box, the loudspeaker, and/or the frame, can be introduced into the cavity which forms the interior of the foam body. When the foam body according to the invention is pulled over the head box, the head box is thus received by the interior cavity of the foam body. The head box is thus enveloped in this specific example. The head box is thus completely covered by the foam body, at least on the top side, the front side and rear side, and both of its lateral areas.

It is thus also possible according to the invention to use a foam body according to the invention in a head restraint without a loudspeaker, that is to say in which no loudspeaker is fastened on the head box. The foam body then envelops these components accordingly, wherein no loudspeaker is present in the head restraint.

The head restraint is thus modularly constructed according to the invention, that is to say, regardless of the variant, whether the head restraint has at least one loudspeaker or does not have a loudspeaker, it is possible to construct it in a simple structural manner in that the head restraint has at least one, preferably one-piece, head box and at least one foam body according to the invention. The foam body according to the invention can thus be used for both variants. Alternatively or additionally, a head box, preferably in one piece, can thus also be used for both variants.

It is furthermore possible according to the invention that the foam body is constructed in multiple parts, for example consists of two individual parts, wherein one part is used for the front side and the other part for the rear side of the head restraint. The individual parts can be brought together according to the invention, so that a single foam body results.

In one advantageous embodiment, the head restraint is connected to a frame on the backrest of a vehicle seat, wherein the head restraint is displaceable relative to the backrest by means of the frame. The frame preferably has two frame rods which are fastened on the head box, for example. The vehicle seat itself preferably consists of a seat surface and a backrest movable for this purpose.

In a further advantageous embodiment, it is possible that in addition the frame rods are also covered, that is to say enveloped, in the region of the head box by the foam body.

The foam body preferably consists of foamed PUR foam, in particular a PUR foam (polyurethane foam) in the MDI variant (methylenediphenyl isocyanate variant).

In a further advantageous embodiment, the width of the head restraint is between 150 to 350 mm, preferably between approximately 215 to 255 mm.

In a further advantageous embodiment, the height of the head restraint is between 150 to 350 mm, preferably between approximately 230 to 270 mm.

In a further advantageous embodiment, the thickness, that is to say the distance between the front and rear, of the head restraint is between 80 to 200 mm, preferably between approximately 120 to 160 mm.

In a further advantageous embodiment, the density of the foam body of the head restraint is between 55 to 70 kg/m³. The compression hardness is preferably between 4.5 and 6.75 kPa. The foam body is preferably designed to be open-pored.

The invention furthermore relates to a method for producing a foam body, in particular a foam body for a head restraint according to any one of claims 1 to 10, characterized in that the foam body is produced in such a way that a contour tool is movably introduced in an area in a tool of a machine tool, so that in this area when the foam body is foamed in the tool, a perforation results due to the contour tool in this area of the foam body during the production of the foam body. After production, the foam body has a perforated area. The perforated area can for example be a hole in the foam body.

The invention also relates to a machine tool for foaming foams in a tool, characterized in that the machine tool has means to be able to carry out the method for producing a foam body.

It is thus possible according to the invention to use an integral foam body in a head restraint that thus almost completely or completely envelops the one-piece head box, in that soundwaves, for example a sound from the loudspeaker of the head restraint, can penetrate in the direction of the front side of the head restraint through the perforated area of the foam body outward in the direction of the person on the seat and in that the soundwaves of the loudspeaker emitted at the rear side are absorbed by the foam body area arranged on the rear side of the head restraint by dissipation in the direction of the rear side of the head restraint, so that according to the invention a resonance volume thus forms in the rear area of the head restraint. A supplementary cover, which could also generate such a resonance volume, is therefore not necessary according to the invention. According to the invention, the area of the integral foam forms this resonance volume suitably in the area of the rear side of the head restraint.

The foam body is designed like a cap in one embodiment, so that the foam body can be pulled over the one-piece head box, the two loudspeakers, and two frame rods in a modular variant, so that this foam body envelops these components of the head restraint, that is to say, covers them. A perforation possibly present in an area of the head restraint is then oriented suitably in the direction of the front of the head restraint in the scope of the envelope so that the sound waves can exit suitably in the direction of the person.

Further components, such as screws, cables, or the like, which are necessary for the function of the head restraint with or without a loudspeaker, are therefore also enveloped in a cap-like foam body.

Further advantages and details of the invention result from the following exemplary embodiment and the associated drawings. In the schematic figures, wherein parts or components that are identical or technically equivalent in the function are provided with the same reference signs:

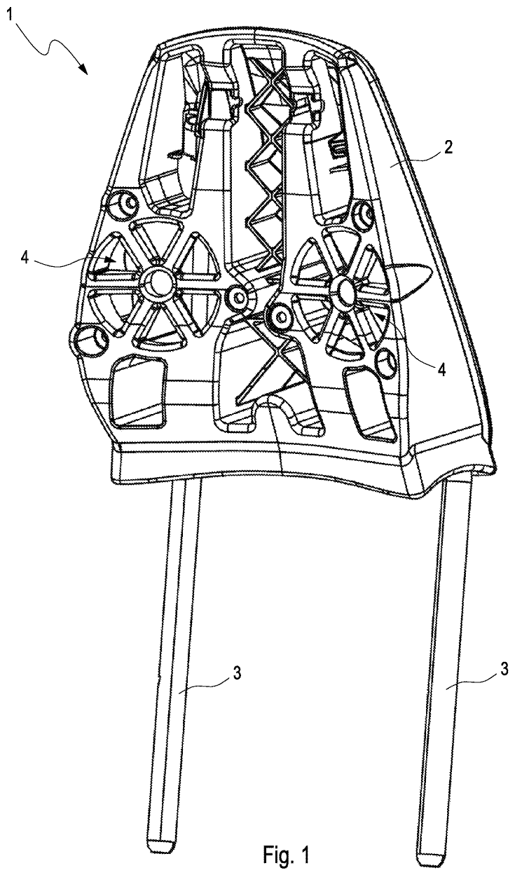

FIG. 1 shows a schematic illustration of a head box with a frame of a head restraint according to the invention in a perspective front view,

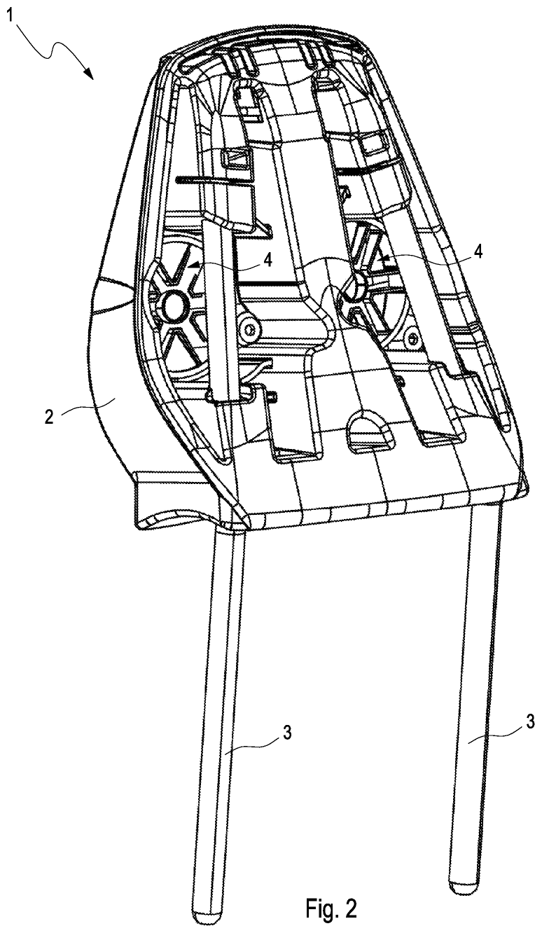

FIG. 2 shows a schematic illustration of a head box with a frame of a head restraint according to the invention in a perspective rear view,

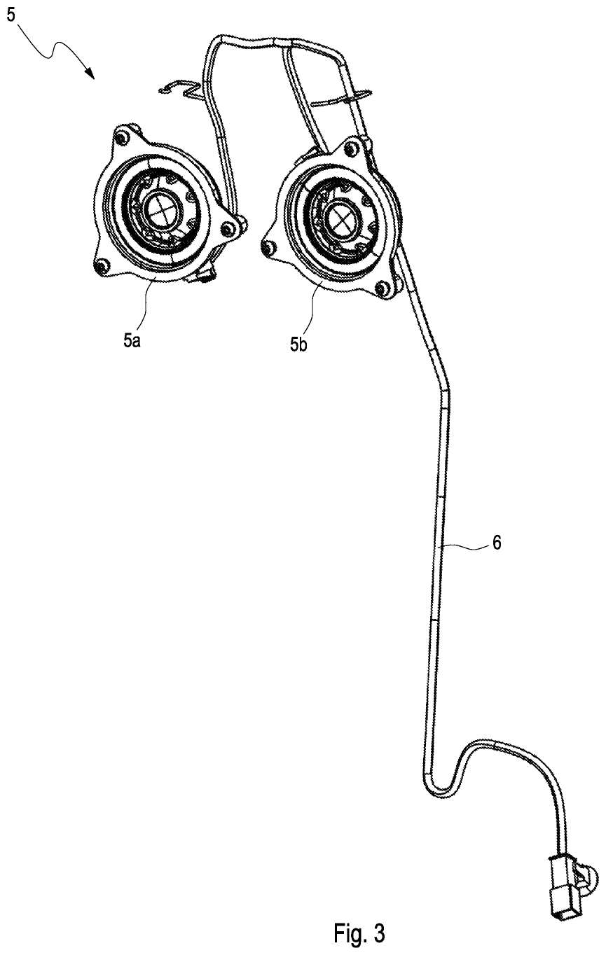

FIG. 3 shows a schematic illustration of a loudspeaker for a head restraint according to the invention in a perspective view, and

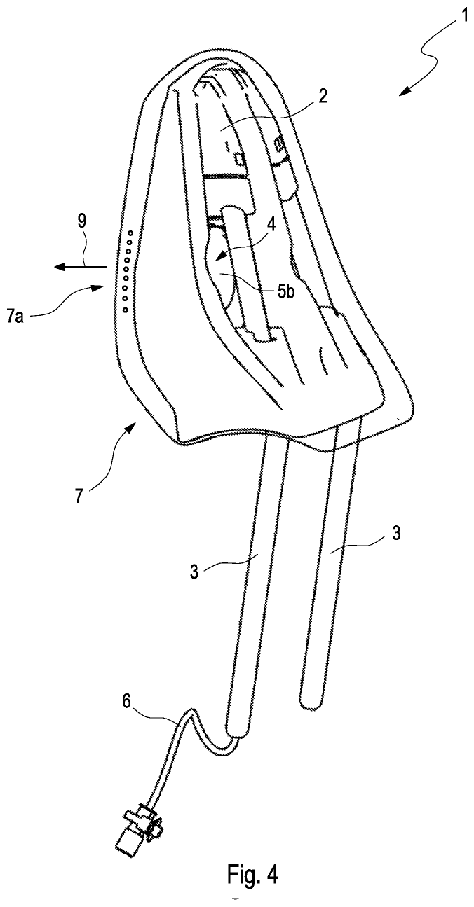

FIG. 4 shows a schematic illustration of a head restraint according to the invention in a perspective side view.

FIG. 1 shows a head restraint 1 according to the invention, wherein only the head box 2 and two frame rods 3 are shown in FIG. 1. FIG. 1 shows the side that faces in the direction of the person on the vehicle seat 1 when, for example, a covering (not shown) and a perforated, one-piece foam body 7 (not shown) have been removed. In this exemplary embodiment, this foam body 7 is formed in such a way that it forms a cavity in its interior.

The side of the head restraint 1 shown in FIG. 1 is thus the front side. FIG. 2 shows the head restraint 1 from FIG. 1 in a view which is arranged opposite to the view from FIG. 1, that is to say the head restraint 1 is shown in FIG. 2 as the rear side.

The head box 2 is formed in one piece and has two areas, each of which enables a loudspeaker 5 to be accommodated. These two areas are designed as loudspeaker recesses 4.

A loudspeaker 5 in the form of two individual loudspeakers 5a, 5b for the head restraint 1 is shown in FIG. 3. Furthermore, FIG. 3 shows a loudspeaker cable 6, using which the respective individual loudspeaker 5a, 5b can be controlled.

The loudspeaker recesses 4 in the head box 2 according to FIGS. 1 and 2 are designed in such a way that the integral head box 2 has at least one opening at these points, so that sound waves from the respective loudspeaker 5 in the loudspeaker recess 4 can be directly incident on the perforated area 7a of the foam body 7 and can subsequently be incident on the covering (not shown). In FIG. 1, six openings are shown which are associated with a respective loudspeaker recess 4 in the head box 2. That is to say, each loudspeaker recess 4 has six openings. The loudspeakers 5 are screwed into the respective loudspeaker recess 4, wherein this is not shown in the figures.

FIG. 4 shows a head restraint 1 according to FIGS. 1 and 2, which has, inter alia, a head box 2 and furthermore two frame rods 3. According to FIG. 4, an individual loudspeaker 5a, 5b according to FIG. 3 is inserted into each of the two loudspeaker recesses 4 and accordingly screwed to the head box 2.

In the direction of the front of the head restraint 1, the foam body 7 is indicated according to FIG. 4, wherein the head box 2 is arranged between loudspeaker 5 and foam body 7 in relation to the front side according to FIG. 4. In relation to the rear side, the foam body 7 conceals the two frame rods 3 and the loudspeaker 5. The rear side of the head restraint 1 is thus also suitably covered or enveloped by the foam body 2. The components are thus located in the cavity of the foam body 7 that forms when the foam body 7 is pulled over the components. According to FIG. 4, the foam body 7 is designed to be perforated in the front area in the direction of the front side. A perforated area 7a is thus formed in this area. The components of the head restraint 1 shown in FIG. 4 are only indicated or can be indicated due to the schematic representation.

The foam body 7 is thus applied to the head box 2 in FIG. 4 in such a way that it envelops the head box 2, the two frame rods 3 in the area of the head box 2, and the loudspeaker 5 in a suitable manner

According to the invention, this head restraint 1 can be covered by a covering (not shown)

When sound 9, that is to say, a tone or a sound wave, comes from a loudspeaker 5, it is conducted through the openings of the loudspeaker troughs 4, subsequently through the perforated area 7a of the sound body 7, that is to say, for example, a through opening like a hole, and the covering (not shown) to the person on the vehicle seat 1. The sound 9 is thus transmitted in the direction of the front side.

The area of the foam body 7 which faces in the direction of the rear side of the head restraint 1 forms the resonance volume between loudspeaker 5 and foam body 7 itself. In this resonance volume of the foam body 7, dissipation of the rear sound takes place, which is generated by the loudspeaker 5 in the direction of the rear side of the head restraint 1. The foam body 7 itself thus acts in its area on the rear side as a resonance body, wherein no further cover in the form of, for example, a further cover cap or the like is necessary to generate such an effect.

1-10. (canceled)

11. A head restraint for a vehicle seat for a vehicle for at least one person, comprising:
a front side facing in the direction of the person sitting on the vehicle seat and a rear side arranged opposite to the front of the head restraint, wherein the head restraint has a head box and at least one foam body, wherein the foam body can be applied around at least part of the head box and at the same time covers at least a part of the head box arranged in the direction of the front side of the head restraint and at the same time covers at least part of the part of the head box arranged in the direction of the rear side of the head restraint and the foam body is designed such that the part of the foam body which covers the rear side of the head restraint, in particular of the head box, can form a resonance volume.

12. The head restraint as claimed in claim 11, wherein the head box is formed in one piece.

13. The head restraint as claimed in claim 11, wherein the head restraint has at least one loudspeaker.

14. The head restraint as claimed in claim 11, wherein the loudspeaker is arranged between a rear side of the head box and an area of the foam body and a front side of the head box is only covered by the foam body.

15. The head restraint as claimed in claim 11, wherein the foam body has at least one area which is perforated.

16. The head restraint as claimed in claim 11, wherein the head restraint has a covering which covers the head box and the foam body, in particular covers the head box, the foam body, and the loudspeaker.

17. The head restraint as claimed in claim 11, wherein the covering is at least partially perforated, in particular is perforated in the area of the front side of the head restraint.

18. The head restraint as claimed in claim 11, wherein the head box has at least one opening through which the sound wave from the loudspeaker can penetrate into the head restraint through the foam body, in particular the perforated area (7a) of the foam body.

19. The head restraint as claimed in claim 11, wherein the foam body is formed in one piece.

20. The head restraint as claimed in claim 11, wherein the foam body is adapted to the contour of the head box, in particular having a cavity inside into which at least a part of the head box can be introduced, so that the head box is at least partially enveloped, in particular enveloping its front side and rear side.

21. The head restraint as claimed in claim 12, wherein the head restraint has at least one loudspeaker.

22. The head restraint as claimed in claim 12, wherein the loudspeaker is arranged between a rear side of the head box and an area of the foam body and a front side of the head box is only covered by the foam body.

23. The head restraint as claimed in claim 13, wherein the loudspeaker is arranged between a rear side of the head box and an area of the foam body and a front side of the head box is only covered by the foam body.

24. The head restraint as claimed in claim 12, wherein the foam body has at least one area which is perforated.

25. The head restraint as claimed in claim 13, wherein the foam body has at least one area which is perforated.

26. The head restraint as claimed in claim 14, wherein the foam body has at least one area which is perforated.

27. The head restraint as claimed in claim 12, wherein the head restraint has a covering which covers the head box and the foam body, in particular covers the head box, the foam body, and the loudspeaker.

28. The head restraint as claimed in claim 13, wherein the head restraint has a covering which covers the head box and the foam body, in particular covers the head box, the foam body, and the loudspeaker.

29. The head restraint as claimed in claim 14, wherein the head restraint has a covering which covers the head box and the foam body, in particular covers the head box, the foam body, and the loudspeaker.

30. The head restraint as claimed in claim 15, wherein the head restraint has a covering which covers the head box and the foam body, in particular covers the head box, the foam body, and the loudspeaker.
